(19) United States
(12) Patent Application Publication
(10) Pub. No.: US 2020/0311734 A1
(43) Pub. Date: Oct. 1, 2020

(54) DYNAMIC TRUST SCORE

(71) Applicant: AMERICAN EXPRESS TRAVEL RELATED SERVICES COMPANY, INC., New York, NY (US)

(72) Inventors: Upendra Mardikar, San Jose, CA (US); Brian Carini, South Glastonbury, CT (US); Royal Hansen, New York, NY (US); Dan H. Toraason, Peoria, AZ (US); Maria Washburn, Phoenix, AZ (US)

(73) Assignee: AMERICAN EXPRESS TRAVEL RELATED SERVICES COMPANY, INC., New York, NY (US)

(21) Appl. No.: 16/365,145

(22) Filed: Mar. 26, 2019

(51) Int. Cl. G06Q 20/40; H04L 9/08; G06Q 20/38; G06N 20/00

(52) U.S. Cl. CPC G06Q 20/4016; H04L 9/0825; G06Q 20/3829; G06Q 2220/00; G06N 20/00; H04L 2209/38; G06Q 20/389

(57) ABSTRACT

Systems and methods for the calculation of a dynamic trust score are disclosed. The dynamic trust score may indicate a likelihood that the consumer will complete the transaction in a positive manner. The system may calculate the dynamic trust score based on various static and dynamic variables including digital identity data, internal data, third-party data, private data, and/or data from the transaction initiated by the consumer.

### FIELD

This disclosure generally relates to computer systems, and more particularly, to systems and methods for the calculation of a dynamic trust score.

### BACKGROUND

Consumers and businesses present different forms of identity verification (e.g., usernames, passwords, government issued identifications, etc.) in order to establish accounts and conduct transactions. However, documents can be forged and passwords can be stolen. Additionally, even a bona fide consumer who has sufficient creditworthiness for a transaction may not be a beneficial consumer for a merchant in various circumstances. For example, various consumer data exists across multiple computers and networks which could potentially alert a merchant of a negative consequence of establishing a relationship or processing a transaction with a consumer. However, it is difficult for existing computer systems to collect the distributed data and provide it to the merchant in a format usable by merchant computer systems.

### SUMMARY

A system, method, and computer readable medium (collectively, the “system”) is disclosed for calculating a dynamic trust score. The system may receive a trust score request including transaction data for a transaction between a user and a merchant. The system may retrieve third party data associated with the user. The system may retrieve user data comprising at least one of transaction account data or historical transaction data associated with the user. The system may calculate a dynamic trust score for the transaction based on the transaction data, the third party data, and the user data. The system may transmit the dynamic trust score to the merchant, wherein the merchant utilizes the dynamic trust score to authorize the transaction.

In various embodiments, the third party data may comprise at least one of reputational data or a textual review of the user. The system may parse the textual review of the third party data to determine a keyword indicating a positive connotation or a negative connotation with the user. The transaction account data may comprise demographic data, an initial risk profile underwriting, a loan history, a timeliness of payments, a transaction dispute history, a revolving transaction account balance, a delinquency history, a fraud score, a credit score, an income level, an education history, and/or a tax history. The historical transaction data may comprise line item data, transaction authorization data, transaction submission data, and/or recent transaction data. The trust score request may also comprise an identity claim associated with the user. The system may calculate the dynamic trust score based on the identity claim.

In various embodiments, the system may encrypt the dynamic trust score with a private key. The system may store the dynamic trust score on a digital identity management blockchain. The system may transmit a public key to the merchant. The public key may be associated with the private key. The merchant may use the public key to retrieve the dynamic trust score from the digital identity management blockchain.

In various embodiments, the system may receive feedback from the merchant on the transaction. The system may modify a trust score algorithm for calculating the dynamic trust score based on the feedback and using machine learning.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. However, a more complete understanding of the present disclosure may be obtained by referring to the detailed description and claims when considered in connection with the drawing figures, wherein like numerals denote like elements.

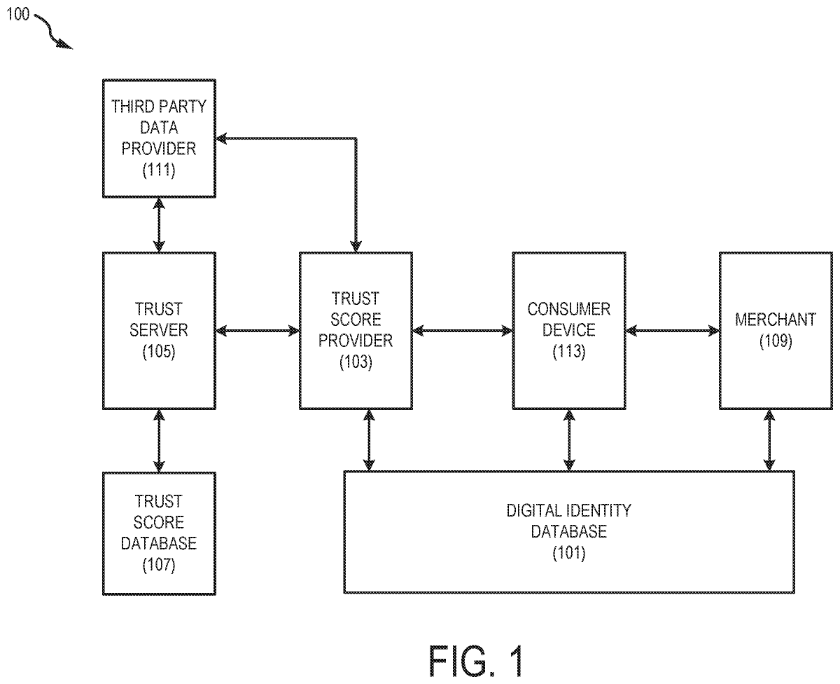

FIG. 1 illustrates a dynamic trust score system, in accordance with various embodiments;

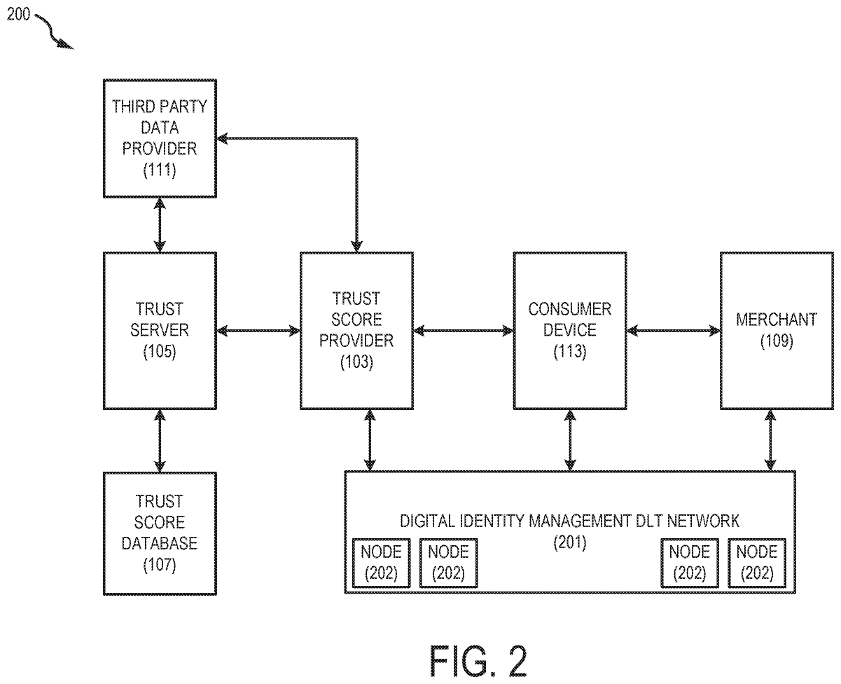

FIG. 2 illustrates a dynamic trust score system comprising, in accordance with various embodiments;

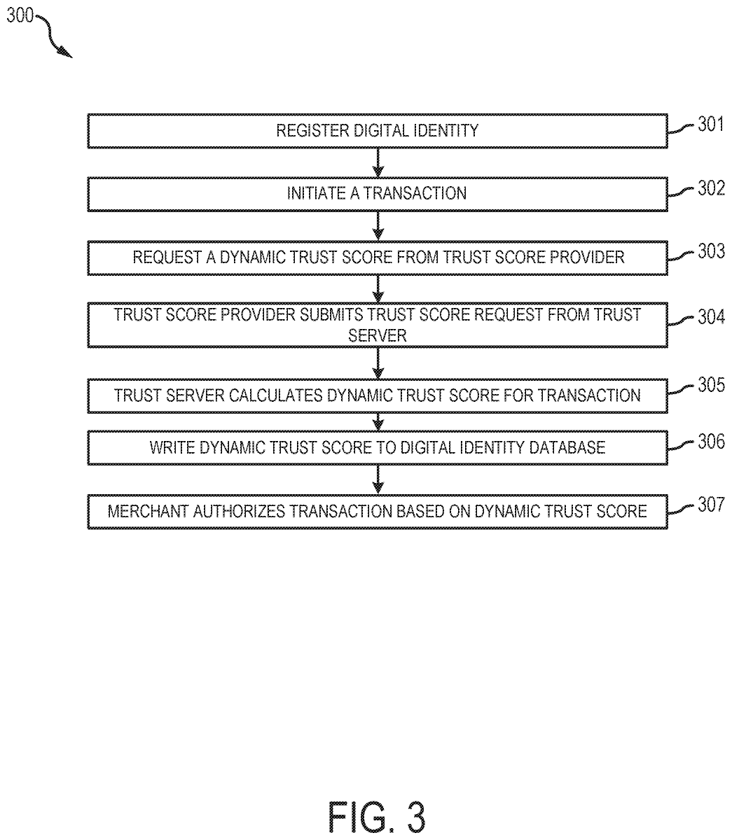

FIG. 3 illustrates process flow for completing a transaction using a dynamic trust score, in accordance with various embodiments;

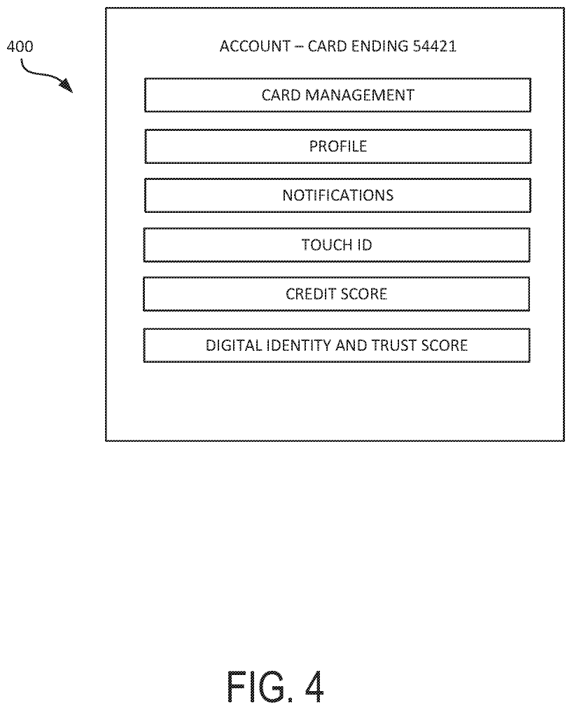

FIG. 4 illustrates a screen shot of an interface for requesting a dynamic trust score, in accordance with various embodiments; and

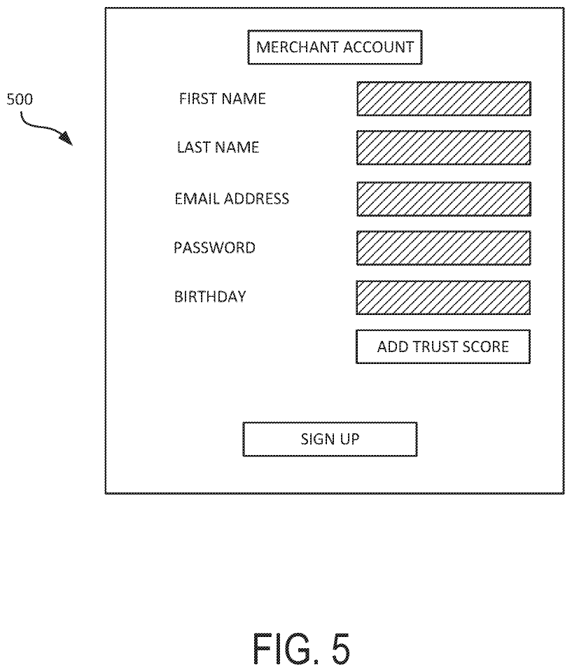

FIG. 5 illustrates a screen shot of an interface for initiating a transaction using a dynamic trust score, in accordance with various embodiments.

### DETAILED DESCRIPTION

In general, in various embodiments, a consumer may initiate a transaction with a merchant. The transaction may include a request for services, a new account request, a purchase of goods, etc. The consumer may request a dynamic trust score from a trust score provider. The dynamic trust score may indicate a likelihood that the consumer will complete the transaction in a positive manner. In various embodiments, the dynamic trust score may be dynamic as the trust score provider recalculates the dynamic trust score dynamically and before the completion of each transaction. Thus, and in accordance with various embodiments, the dynamic trust score may be different from typical credit scores and similar static variables indicating creditworthiness. The trust score provider may calculate the dynamic trust score based on various static and dynamic variables, such as, for example, digital identity data, internal data, third-party data, private data, and the transaction initiated by the consumer. In various embodiments, the trust score provider may also implement machine learning techniques to aid in calculating the dynamic trust score.

Referring to FIG. 1, a dynamic trust score system 100 is illustrated according to various embodiments. System 100 may include various computing devices, software modules, networks, and data structures in communication with one another. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing.

In various embodiments, system 100 may comprise one or more of a digital identity database 101, a trust score provider 103, a trust server 105, a trust score database 107, a merchant 109, a third party data provider 111, and a consumer device 113. One or more system 100 components may be configured to interact with digital identity database 101 to review, collect, and/or submit digital identity information. In that respect, each system 100 component may comprise any suitable entity, system, network, or the like desiring to obtain, review, or submit digital identity information.

Digital identity database 101 may be configured to store and maintain digital identity data, including, for example identity claims corresponding to one or more users. For example, an employment claim may indicate that an employer has verified that the user works for the employer. The employment claim may comprise data regarding the employment of the user, together with the verification from the employer. As a further example, a college transcript claim may indicate that a college has verified that the user attended the college. The college transcript claim may comprise transcript data (e.g., classes, grades, etc.) together with the verification from the college. As a further example, a government identity claim may indicate that a government agency, such as the social security administration, has verified that the user is who they claim to be. Sensitive data (e.g., social security numbers) may be omitted from the identity claim to increase security of the data. In various embodiments, the digital identity data may include any other identity claim capable of verifying who the user is. Digital identity database 101 may comprise one or more hardware and/or software components, and may comprise one or more databases capable of storing and maintaining the digital identity data.

In various embodiments, digital identity database 101 may comprise a distributed ledger. For example, and with reference to FIG. 2, a system 200 may be based on one or more digital ledger technologies (“DLT”), as described herein, and may simplify and automate identity management and related processes by using the DLTs as a distributed and tamper-proof data store.

System 200 may comprise a digital identity management DLT network 201 configured to maintain a digital ledger, such as blockchain or tangle, in accordance with various embodiments. DLT network 201 may be a peer-to-peer network that is private, federated, and/or public in nature (e.g., ETHEREUM®, Bitcoin, Hyperledger® Indy, etc.). Federated and private networks may offer improved control over the content of the digital ledger and public networks may leverage the cumulative computing power of the network to improve security. DLT network 201 may comprise various digital ledger nodes 202 (e.g., consensus participants) in electronic communication with each other, as discussed further herein. Each digital ledger node 202 may comprise a computing device configured to write blocks to the digital ledger and validate blocks of the digital ledger. The computing devices may take the form of a computer or processor, or a set of computers and/or processors or application specific integrated circuits (ASICs), although other types of computing units or systems may also be used. Exemplary computing devices include servers, pooled servers, laptops, notebooks, hand held computers, personal digital assistants, cellular phones, smart phones (e.g., iPhone®, BlackBerry®, Android®, etc.) tablets, wearables (e.g., smart watches and smart glasses), Internet of things (IOT) devices or any other device capable of receiving data over network. Each computing device may run applications to interact with DLT network 201, communicate with other devices, perform crypto operations, and otherwise operate within system 200. The computing devices may run a client application that can be a thin client (web), hybrid (i.e. web and native, such as iOS and Android), or native application to make API calls to interact with the digital ledger, such as a web3 API compatible with blockchain databases maintained by ETHEREUM®.

The digital ledger may be a distributed database, distributed ledger, or the like that maintains records in a readable manner and that is resistant to tampering. The digital ledger may comprise a system of blocks containing data that are interconnected by reference to the previous block. The blocks can hold digital identities, and/or other information as desired. Each block may link to the previous block and may include a timestamp. Data can be added to the digital ledger by establishing consensus between the digital ledger nodes 202 based on proof of work, proof of stake, practical byzantine fault tolerance, delegated proof of stake, or other suitable consensus algorithms. When implemented in support of system 200, the digital ledger may serve as an immutable log for digital identities, and/or other information as desired.

In various embodiments, DLT network 201 may use a Hierarchical Deterministic (HD) solution and may use BIP32, BIP39, and/or BIP44, for example, to generate an HD tree of public addresses. System 200 may include various computing devices configured to interact with DLT network 201 either via a blockchain client, such as GETH, or via API calls using a blockchain as a service provider, such as MICROSOFT AZURE® or Blockapps STRATO, for example. The various computing devices of system 200 may be configured to store digital identity related data.

The various system 200 components (e.g., trust score provider 103, consumer device 113, merchant 109, etc.) may be in electronic communication with DLT network 201 and may run applications to interact with DLT network 201, transfer files over a network with other computing devices, perform crypto operations, and otherwise operate within system 200. For example, each system component may comprise a blockchain node configured to interact with DLT network 201. A blockchain address may be uniquely assigned to each system 200 component to function as a unique identifier for each respective system component.

In various embodiments, and with reference again to FIG. 1, trust score provider 103 may comprise one or more hardware, software, and/or database components. For example, trust score provider 103 may comprise one or more network environments, servers, computer-based systems, processors, databases, and/or the like. Trust score provider 103 may comprise at least one computing device in the form of a computer or processor, or a set of computers/processors, although other types of computing units or systems may be used such as, for example, a server, web server, pooled servers, or the like. In various embodiments, trust score provider 103 may also include software, such as services, APIs, and the like, configured to perform various operations discussed herein. In various embodiments, trust score provider 103 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein. Trust score provider 103 may be in electronic communication with trust server 105, consumer device 113, one or more third party data providers 111, and/or digital identity database 101.

In accordance with various embodiments, the trust score provider 103 may comprise one or more servers operated by a transaction account issuing entity such as, for example, CITIGROUP®, CAPITAL ONE®, BANK OF AMERICA®, DISCOVER®, SYNCHRONY FINANCIAL®, AMERICAN EXPRESS®, WELLS FARGO®, BARCLAYS®, U.S. BANK®, DELTA AIRLINES®, MORGAN STANLEY®, and/or the like.

The trust server 105 may comprise one or more hardware, software, and/or database components configured to communicate with the trust score provider 103, the trust score database 107, and/or the third party data provider 111 to calculate a dynamic trust score. In various embodiments, the trust score provider 103, the trust server 105, and/or the trust score database 107 may be operated by the same entity, such as a transaction account issuer. For example, trust server 105 may comprise one or more network environments, servers, computer-based systems, processors, databases, and/or the like. Trust server 105 may comprise at least one computing device in the form of a computer or processor, or a set of computers/processors, although other types of computing units or systems may be used such as, for example, a server, web server, pooled servers, or the like. In various embodiments, trust server 105 may also include software, such as services, APIs, and the like, configured to perform various operations discussed herein. In various embodiments, trust server 105 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein. Exemplary processors may include any logic device capable of performing the logical operations disclosed herein, such as, for example, a central processing unit (CPU), an accelerated processing unit (APU), a digital signal processor (DSP), a field programmable gate array (FPGA), an application specific integrated circuit (ASIC), or the like.

In various embodiments, the trust server 105 may implement various artificial intelligence techniques to aid in generating the dynamic trust scores. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. For example, and in accordance with various embodiments, the trust server 105 may implement machine learning algorithms and models to aid in generating the dynamic trust scores. The trust server 105 may implement any suitable machine learning model or algorithm and may be supervised or unsupervised. The machine learning model may be trained (e.g., using historical data correlated to various trust scores) to aid in weighing various variables to calculate the dynamic trust score. For example, and in accordance with various embodiments, the machine learning algorithm may be supervised and may be configured to evaluate and weight data from the transaction, the digital identity database 101, from the trust score database 107, and from the third party data providers 111. In various embodiments, machine learning networks and/or subject matter experts may be configured to supervise the model and identify words and phrases that should be weighted more or less. In various embodiments, the machine learning model may comprise random forest models, gradient boosting models, or any other suitable or desired model. In various embodiments, the trust server 105 may also implement reinforcement learning techniques to enhance the machine learning algorithm.

The trust score database 107 may comprise one or more databases which store transaction data. In various embodiments, the trust score database 107 may comprise a big data system, such as an exemplary big data system provided by HADOOP® or CORNERSTONE®. For example, and in accordance with various embodiments, the trust score database 107 may comprise a distributed computing cluster configured to process and store big data sets with some of nodes comprising a distributed storage system and some of nodes comprising a distributed processing system. In that regard, the distributed computing cluster may be configured to support a HADOOP® software distributed file system (HDFS) as specified by the Apache Software Foundation at www.hadoop.apache.org/docs. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

The merchant 109 may comprise various hardware, software, and/or database components operated by any suitable online or in-person merchant entity such as AIRBNB®, UBER®, YELP®, AMAZON®, EBAY®, WALMART®, TARGET®, or the like. For example, the merchant 109 may comprise one or more network environments, servers, computer-based systems, processors, databases, datacenters, and/or the like. In various embodiments, the merchant 109 may be computer based, and may comprise a processor, a tangible non-transitory computer-readable memory, and/or a network interface, along with other suitable system software and hardware components. Instructions stored on the tangible non-transitory memory may allow the merchant 109 to perform various operations, as described herein. The merchant 109 may be in electronic communication with consumer device 113 and/or digital identity database 101.

The consumer device 113 may comprise a computing device, such as a smartphone or personal computer, configured to enable the consumer device 113 to communicate electronically with the digital identity database 101, the trust score provider 103, and/or the merchant 109. For example, the consumer device 113 may comprise any suitable hardware, software, and/or database components capable of sending, receiving, and storing data. The consumer device 113 may comprise a personal computer, personal digital assistant, cellular phone, smartphone (e.g., IPHONE®, BLACKBERRY®, etc.), internet of things (IoT) device, and/or the like. The consumer device 113 may comprise an operating system such as, for example, a WINDOWS® mobile operating system, an ANDROID® operating system, APPLE® IOS®, a BLACKBERRY® operating system, a LINUX® operating system, and the like. The consumer device 113 may also comprise software components installed on The consumer device 113 and configured to allow a user, via the consumer device 113, access to various systems, services, and components in system 100. For example, the consumer device 113 may comprise a web browser (e.g., MICROSOFT INTERNET EXPLORER®, GOOGLE CHROME®, etc.), an application, a micro-app or mobile application, or the like configured to enable the consumer device 113 to interact with the merchant 109 (e.g., to initiate a transaction, purchase various goods or services, etc.).

In various embodiments, and with reference again to FIG. 2, the consumer device 113 may comprise a digital identity wallet. The digital identity wallet may comprise any suitable distributed-ledger based wallet, such as, for example, ETHEREUM® GETH, ETHEREUM® MetaMask, eth-lightwallet, MyEtherWallet, and/or any other suitable blockchain interface technologies. The digital identity wallet may serve as a blockchain interface accessible by users and applications installed on the consumer device 113. For example, the digital identity wallet may be configured to register the consumer device 113 with the blockchain, request public key (e.g., blockchain address) and private key pairs from DLT network 201, and/or otherwise access and interact with blockchain account information.

In various embodiments, and with reference again to FIG. 1, the trust score provider 103 may comprise any suitable combination of hardware, software, a mobile application, a web interface, or the like accessible. The trust score provider 103 may be configured to receive transaction requests. For example, the transaction request may be received in response to a consumer initiating a transaction with the merchant 109. Each transaction request may comprise any suitable transaction related data, such as, for example, a transaction account number, a transaction instrument number, a transaction instrument expiration date, transaction account billing information (e.g., address, city, state, zip code, etc.), a user email address, an IP address (e.g., from an online purchaser), and/or the like.

The trust score provider 103 may be configured to perform an initial authorization assessment on the transaction request. The trust score provider 103 may perform the initial authentication assessment using any suitable technical process known in the art. The initial authentication assessment may determine whether (and to what extent) the consumer is authorized to transfer sufficient funds to the merchant 109 via a transaction account, such as a credit card account, as well as whether there is an unacceptable risk of fraud based on the transaction request. The trust score provider 103 may also communicate with the trust server 105 request a dynamic trust score for the transaction request.

In various embodiments, the third party data providers 111 may comprise one or more servers, computer-based systems, network environments, or the like configured to share data with the trust score provider 103 and/or the trust server 105. In various embodiments, the third party data provider 111 may comprise an entity which collects ratings and other reputational data about businesses and individuals, such as YELP®, UBER®, EBAY®, AIRBNB®, LINKEDIN®, etc. In various embodiments, the third party data provider 111 and the trust score provider 103 may share data via a private blockchain. The trust score provider 103 and the third party data provider 111 may each write data to the private blockchain, which may be subsequently accessed by the trust score provider 103.

Referring now to FIG. 3 the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and elements depicted in FIG. 3, but also to the various system components as described above with reference to FIGS. 1 and 2. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below. Unless otherwise specifically noted, articles depicted in the drawings are not necessarily drawn to scale.

With specific reference to FIG. 3, a process flow 300 for completing a transaction using a dynamic trust score is illustrated according to various embodiments. A user may interact with the consumer device to register a digital identity (step 301). In various embodiments, the digital identity may be stored in the digital identity database 101. In various embodiments, the digital identity may be stored in the digital identity wallet in the consumer device, and may be in electronic communication with the digital identity management DLT network. The digital identity may comprise one or more identity claims. For example, an employment claim may indicate that an employer has verified that the user works for the employer; a college transcript claim may indicate that a college has verified that the user attended the college; a government identity claim may indicate that a government agency, such as the social security administration, has verified that the user is who they claim to be; and/or the like.

In various embodiments, the verifying entity may write the identity claim to the digital identity database. In various embodiments, the verifying entity may write the identity claim to the user's digital identity block in the blockchain, and the digital identity wallet may store the various identity claims. The identity claim may be written using protocols such as those utilized by Self Sovrin Identity protocols or HYPERLEDGER® Indy protocols. In various embodiments, other DLT systems, such as Tangle, may be used in addition to, or in place of, blockchain systems.

The user may initiate a transaction with a merchant (step 302). For example, the transaction may include a request to create an account with the merchant, or a request to purchase goods or services from the merchant. The user may initiate the transaction by accessing a webpage or mobile application operated by the merchant, and/or by interacting with the merchant at a kiosk, brick-and-mortar store, or similar physical location. The user may input transaction information, which may include username, password, transaction account number, address, phone, etc.

The user may request a dynamic trust score from the trust score provider (step 303). In various embodiments, the merchant may prompt the user to request the dynamic trust score from the trust score provider, such as by allowing the user to click on or select a button which initiates a request for the dynamic trust score. In various embodiments, the user may request the dynamic trust score from the trust score provider without prompting from the merchant, which may occur either prior to, during or after initiating the transaction with the merchant. For example, the user may access a mobile application of the trust score provider, and the user may select a trust score request button.

After the user selects the button to initiate the request, the trust score provider may submit a trust score request from a trust server via a REST API call (step 304). The dynamic trust score request may comprise information including the user name, the identity claims stored in the digital identity database, the merchant involved in the transaction, a description of the items or services involved in the transaction, etc.

The trust server may calculate a dynamic trust score for the transaction (step 305). The dynamic trust score may indicate a likelihood that the user will complete the transaction in a positive manner. For example, the transaction may be for the user to rent a hotel room, rental house, etc., and the dynamic trust score may indicate a likelihood that the user is who they say they are, that the user will complete payment for the transaction, and that the user will not damage the rental property. In various embodiments, the transaction may be for escrows for houses, home equity financing, sending rental goods nationally and internationally, etc.

To calculate the dynamic trust score, the trust server may evaluate data from the transaction, the digital identity database, from the dynamic trust score database, and from the third party data providers. For example, the data from the digital identity database may indicate that the user is who they claim to be based on various data (e.g., identity claims) stored on or available to the digital identity database.

The dynamic trust score database may comprise user data, such as, for example, transaction account data and historical transaction data. The transaction account data may be static and may comprise data about the user, such as, for example, demographic data, transaction account data (e.g., savings account, credit card account, type of credit card account, etc.), an initial risk profile underwriting, loan history, timeliness of payments, transaction dispute history, revolving transaction account balances, delinquency history, a fraud score, a credit score, income, education history, tax history based on zip code, etc. The historical transaction data may be dynamic and may comprise data about past transactions involving the user, such as, for example, line item data (e.g., specific products or services purchased), transaction authorization data, transaction submission data, historical or recent transactions, etc.

In various embodiments, data from the dynamic trust score database may be evaluated against the transaction data. For example, wherein historical transaction data from the dynamic trust score database indicates that the customer recently purchased paint, drywall repair products, or the like, the dynamic trust score may be negatively affected in response to the current transaction being renting a hotel room, rental house, or the like.

The third party data sources may comprise reputational data for the user. For example, the trust server may average user rankings or star ratings from multiple third party data sources to determine reputational data for the user. In various embodiments, the trust server may parse textual reviews of the user and identify words or phrases which may indicate a positive or negative connotation with the user. For example, a review of the user which contains the word “damage” may negatively affect the user's trust score.

The trust server may weight the third party data sources, or specific data entries within the third party data sources, based on a relevancy to the current transaction. For example, if the current transaction is for a hotel room, the trust server may more heavily weight reviews which contain the word “hotel” or are from a hotel services provider than reviews which are less relevant to hotels, such as reviews of the user's painting skills. In various embodiments, the trust server may utilize a supervised classification model. Machine learning networks and/or subject matter experts may identify words and phrases that should be weighted more or less.

The trust server may calculate a dynamic trust score for the transaction. In various embodiments, the dynamic trust score may be calculated on a scale of 0-100. However, many different scales, including non-numerical scales may be used. As one example, one-third of the dynamic trust score may be based on the likelihood that the user is who they claim to be, one-third of the dynamic trust score may be based on the likelihood that the user will complete payment for the transaction, and one-third of the dynamic trust score may be based on the reputational data of the user. However, those skilled in the art will recognize that many different specific algorithms may be used to calculate the dynamic trust score based on similar data. The trust server may return the dynamic trust score to the trust score provider.

The trust server may utilize machine learning to calculate the dynamic trust score and/or to improve the dynamic trust score calculations over time. For example, and in accordance with various embodiments, a machine learning model may be trained to identify and correlate data points with failed or negative transactions. Based on the correlation, the trust server may alter the algorithm to improve the trust score calculation. As a further example, and in accordance with various embodiments, after the trust server has calculated a dynamic trust score for a transaction, the merchant may subsequently notify the trust server whether the transaction was positive or negative. The trust server may alter the algorithm based on the feedback and continue to improve the trust score calculation.

The trust score provider may write a digital identity entry including the dynamic trust score to the digital identity database (step 306). In various embodiments, the trust score provider may create an asymmetric key pair, including a private key and a public key. The trust score provider may generate the asymmetric key pair using any suitable technique and asymmetric algorithm, such as, for example, RSA, DSA, elliptic curve cryptography, or the like. The trust score provider may encrypt and store the private key. The trust score provider may transmit the public key to the consumer device and/or the merchant, which may encrypt and store locally the public key. In various embodiments, the trust score provider may also encrypt and store locally the public key. In various embodiments, the trust score provider may write the digital identity entry to the digital identity management DLT network. In that regard, the public key may comprise a blockchain address.

The trust score provider may transmit the dynamic trust score to the merchant (step 306). In various embodiments, the trust score provider may transmit the dynamic trust score directly to the merchant, such as via an API between the trust score provider and the merchant. In various embodiments, the trust score provider may transmit the dynamic trust score to the merchant via the consumer device. In various embodiments, the trust score provider may transmit the public key to the merchant, either via the API or via the consumer device. The trust score provider may then use the public key to retrieve the dynamic trust score from the digital identity database.

The merchant may authorize the transaction based at least in part on the dynamic trust score (step 307). For example, if the user is requesting to create an account with the merchant, but the user has a low trust score, the merchant may deny the registration. If the user is requesting to purchase a service from the merchant, the merchant may decide to decline (or revise the service price) to provide the service based on a low user trust score, even if the payment is authorized by a transaction account issuer. Thus, the merchant may make better informed decisions on entities with which to conduct business. The merchant may transmit an account claim to the digital identity wallet and write the account claim to the digital identity database. In that respect, the dynamic trust score may be dynamically generated before each transaction (or in a defined period) such that a merchant may decline a second transaction the same day of authorizing a first transaction for the user, in response to data changing and negatively impacted the user's dynamic trust score.

Referring to FIG. 4, a screenshot of an interface 400 for requesting a dynamic trust score is illustrated, according to various embodiments. The user may utilize a user device to access an account with the trust score provider. In various embodiments, the trust score provider may be a financial transaction account issuer. The interface 400 may provide the user with options to select various account services, such as card management, profile settings, notifications, touch ID settings, credit score retrieval, or digital identity and trust score services. In response to the user selecting the digital identity and trust score services, the trust score provider may display or transmit a dynamic trust score to the user. In various embodiments, the trust score provider may provide the user with options for merchants with which the trust score provider can provide digital identity or trust score services. The trust score provider may transmit the dynamic trust score or digital identity information to one or more of the merchants.

Referring to FIG. 5, a screen shot of an interface 500 for initiating a transaction using a dynamic trust score is illustrated according to various embodiments. The interface 500 may include standard fields for creating an account with a merchant, such as first name, last name, email address, password, and birthday. In various embodiments, such as if the user is directed to the merchant webpage after requesting digital identity services from the trust score provider, as described with reference to FIG. 4, the trust score provider may have provided the dynamic trust score to the merchant prior to the user completing the account registration page. However, in various embodiments, the interface 500 may provide an option for the user to add a dynamic trust score. In response to the user selecting the “add trust score” button, the merchant may request a dynamic trust score from the trust score provider. The merchant may make a decision whether to authorize a transaction, such as creating an account for the user, based in part on the dynamic trust score provided by the trust score provider.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

As used herein, “transmit” may include sending at least a portion of electronic data from one system component to another. Additionally, as used herein, “data,” “information,” or the like may include encompassing information such as commands, queries, files, messages, data for storage, and the like in digital or any other form.

As used herein, “electronic communication” may comprise a physical coupling and/or non-physical coupling capable of enabling system components to transmit and receive data. For example, “electronic communication” may refer to a wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZIGBEE® protocol maintained by the ZigBee alliance), a cellular protocol, an infrared protocol, an optical protocol, or any other protocol capable of transmitting information via a wired or wireless connection.

One or more of the system components may be in electronic communication via a network. As used herein, the term “network” may further include any cloud, cloud computing system, or electronic communications system or method that incorporates hardware and/or software components. Communication amongst the nodes may be accomplished through any suitable communication channels such as, for example, a telephone network, an extranet, an intranet, Internet, point of interaction device (personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using Internetwork Packet Exchange (IPX), APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the Internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

The various system components may be independently, separately or collectively suitably coupled to the network via data links which includes, for example, a connection to an Internet Service Provider (ISP) over the local loop as is typically used in connection with standard modem communication, cable modem, DISH NETWORKS®, ISDN, DSL, or various wireless communication methods. It is noted that the network may be implemented as other types of networks, such as an interactive television (ITV) network. Moreover, the system contemplates the use, sale or distribution of any goods, services or information over any network having similar functionality described herein.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of the system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system. For example, and in accordance with various embodiments, the components of system 100 may be in direct electronic communication with each other via a bus, network, and/or the like.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies. The ALEXA® system, GOOGLE HOME® system, and HOMEPOD® system, may each provide cloud-based voice activation services that can assist with tasks, entertainment, general information, and more. All the ALEXA® devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME®, and HOMEPOD® systems may also allow the user to access information about eligible transaction accounts linked to an online account across all digital assistant-enabled devices.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various conventional support software and drivers typically associated with computers.

A web client includes any device or software which communicates via any network, such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE® CHROME® software, APPLE® SAFARI® software, or any other of the myriad software packages available for browsing the internet.

In various embodiments, one or more servers discussed herein may include application servers (e.g. WEBSPHERE®, WEBLOGIC®, JBOSS®, POSTGRES PLUS ADVANCED SERVER®, etc.). In various embodiments, the server may include web servers (e.g. Apache, IIS, GOOGLE® Web Server, SUN JAVA® System Web Server, JAVA® Virtual Machine running on LINUX® or WINDOWS® operating systems).

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network. For more information on distributed ledgers implementing features and functionalities of blockchain, see U.S. application Ser. No. 15/266,350 titled SYSTEMS AND METHODS FOR BLOCKCHAIN BASED PAYMENT NETWORKS and filed on Sep. 15, 2016, U.S. application Ser. No. 15/682,180 titled SYSTEMS AND METHODS FOR DATA FILE TRANSFER BALANCING AND CONTROL ON BLOCKCHAIN and filed Aug. 21, 2017, U.S. application Ser. No. 15/728,086 titled SYSTEMS AND METHODS FOR LOYALTY POINT DISTRIBUTION and filed Oct. 9, 2017, U.S. application Ser. No. 15/785,843 titled MESSAGING BALANCING AND CONTROL ON BLOCKCHAIN and filed on Oct. 17, 2017, U.S. application Ser. No. 15/785,870 titled API REQUEST AND RESPONSE BALANCING AND CONTROL ON BLOCKCHAIN and filed on Oct. 17, 2017, U.S. application Ser. No. 15/824,450 titled SINGLE SIGN-ON SOLUTION USING BLOCKCHAIN and filed on Nov. 28, 2017, U.S. application Ser. No. 15/824,513 titled TRANSACTION AUTHORIZATION PROCESS USING BLOCKCHAIN and filed on Nov. 28, 2017, U.S. application Ser. No. 15/943,168 titled TRANSACTION PROCESS USING BLOCKCHAIN TOKEN SMART CONTRACTS and filed on Apr. 2, 2018, U.S. application Ser. No. 15/943,271 titled FRAUD MANAGEMENT USING A DISTRIBUTED DATABASE and filed on Apr. 2, 2018, U.S. application Ser. No. 16/012,598 titled BUYER-CENTRIC MARKETPLACE USING BLOCKCHAIN and filed on Jun. 19, 2018, U.S. application Ser. No. 16/051,126 titled System and Method for Transaction Account Based Micro-Payments and filed on Jul. 31, 2018, U.S. application Ser. No. 16/052,416 titled PROCUREMENT SYSTEM USING BLOCKCHAIN and filed on Aug. 1, 2018, U.S. application Ser. No. 16/054,185 titled BLOCKCHAIN-ENABLED DATASETS SHARED ACROSS DIFFERENT DATABASE SYSTEMS and filed on Aug. 3, 2018, U.S. application Ser. No. 16/168,477 titled MULTI-MERCHANT LOYALTY POINT PARTNERSHIP and filed on Oct. 23, 2018, U.S. application Ser. No. 16/217,654 titled PEER-TO-PEER CONFIDENTIAL DOCUMENT EXCHANGE and filed on Dec. 12, 2018, U.S. application Ser. No. 16/217,734 titled ZERO-KNOWLEDGE PROOF PAYMENTS USING BLOCKCHAIN and filed on Dec. 12, 2018, U.S. application Ser. No. 16/220,235 titled TRANSACTION ACCOUNT DATA MAINTENANCE USING BLOCKCHAIN and filed on Dec. 14, 2018, and U.S. application Ser. No. 16/239,017 titled HYBRID IDENTITY AS A SERVICE FOR DECENTRALIZED BROWSER BASED WALLER and filed on Jan. 3, 2019, the contents of which are each incorporated by reference in its entirety.

One skilled in the art will also appreciate that, for security reasons, any databases, systems, devices, servers, or other components of the system may consist of any combination thereof at a single location or at multiple locations, wherein each database, system, device, server, and/or other component includes any of various suitable security features, such as firewalls, access codes, encryption, decryption, compression, decompression, and/or the like.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

What is claimed is:

1. A method comprising:
receiving, by a computer-based system, a trust score request including transaction data for a transaction between a user and a merchant;
retrieving, by the computer-based system, third party data associated with the user;
retrieving, by the computer-based system, user data comprising at least one of transaction account data or historical transaction data associated with the user;
calculating, by the computer-based system and based on the transaction data, the third party data, and the user data, a dynamic trust score for the transaction; and
transmitting, by the computer-based system, the dynamic trust score to the merchant, wherein the merchant utilizes the dynamic trust score to authorize the transaction.

2. The method of claim 1, wherein the third party data comprises at least one of reputational data or a textual review of the user.

3. The method of claim 2, further comprising parsing, by the computer-based system, the textual review of the third party data to determine a keyword indicating a positive connotation or a negative connotation with the user.

4. The method of claim 1, wherein the transaction account data comprises at least one of demographic data, an initial risk profile underwriting, a loan history, a timeliness of payments, a transaction dispute history, a revolving transaction account balance, a delinquency history, a fraud score, a credit score, an income level, an education history, or a tax history.

5. The method of claim 1, wherein the historical transaction data comprises at least one of line item data, transaction authorization data, transaction submission data, or recent transaction data.

6. The method of claim 1, wherein the trust score request comprises an identity claim associated with the user, and wherein the dynamic trust score is calculated based on the identity claim.

7. The method of claim 1, further comprising storing, by the computer-based system, the dynamic trust score on a digital identity management blockchain.

8. The method of claim 7, further comprising:
encrypting, by the computer-based system, the dynamic trust score with a private key prior to storing the dynamic trust score on the digital identity management blockchain; and
transmitting, by the computer-based system, a public key to the merchant, wherein the public key is associated with the private key, and wherein the merchant uses the public key to retrieve the dynamic trust score from the digital identity management blockchain.

9. The method of claim 1, further comprising modifying, by the computer-based system and based on feedback from the merchant, a trust score algorithm using machine learning.

10. A system, comprising:
a processor; and
a tangible, non-transitory memory configured to communicate with the processor, the tangible, non-transitory memory having instructions stored thereon that, in response to execution by the processor, cause the processor to perform operations comprising:
receiving, by the processor, a trust score request including transaction data for a transaction between a user and a merchant;
retrieving, by the processor, third party data associated with the user;
retrieving, by the processor, user data comprising at least one of transaction account data or historical transaction data associated with the user;
calculating, by the processor and based on the transaction data, the third party data, and the user data, a dynamic trust score for the transaction; and
transmitting, by the processor, the dynamic trust score to the merchant, wherein the merchant utilizes the dynamic trust score to authorize the transaction.

11. The system of claim 10, wherein the third party data comprises at least one of reputational data or a textual review of the user.

12. The system of claim 11, further comprising parsing, by the processor, the textual review of the third party data to determine a keyword indicating a positive connotation or a negative connotation with the user.

13. The system of claim 10, wherein the transaction account data comprises at least one of demographic data, an initial risk profile underwriting, a loan history, a timeliness of payments, a transaction dispute history, a revolving transaction account balance, a delinquency history, a fraud score, a credit score, an income level, an education history, or a tax history, and wherein the historical transaction data comprises at least one of line item data, transaction authorization data, transaction submission data, or recent transaction data.

14. The system of claim 10, wherein the trust score request comprises an identity claim associated with the user, and wherein the dynamic trust score is calculated based on the identity claim.

15. The system of claim 10, further comprising:
encrypting, by the processor, the dynamic trust score with a private key prior to storing the dynamic trust score on a digital identity management blockchain;
storing, by the processor, the dynamic trust score on the digital identity management blockchain; and
transmitting, by the processor, a public key to the merchant, wherein the public key is associated with the private key, and wherein the merchant uses the public key to retrieve the dynamic trust score from the digital identity management blockchain.

16. An article of manufacture including a non-transitory, tangible computer readable storage medium having instructions stored thereon that, in response to execution by a computer-based system, cause the computer-based system to perform operations comprising:
receiving, by the computer-based system, a trust score request including transaction data for a transaction between a user and a merchant;
retrieving, by the computer-based system, third party data associated with the user;
retrieving, by the computer-based system, user data comprising at least one of transaction account data or historical transaction data associated with the user;
calculating, by the computer-based system and based on the transaction data, the third party data, and the user data, a dynamic trust score for the transaction; and
transmitting, by the computer-based system, the dynamic trust score to the merchant, wherein the merchant utilizes the dynamic trust score to authorize the transaction.

17. The article of manufacture of claim 16, further comprising parsing, by the computer-based system, a textual review of the third party data to determine a keyword indicating a positive connotation or a negative connotation with the user.

18. The article of manufacture of claim 16, wherein the transaction account data comprises at least one of demographic data, an initial risk profile underwriting, a loan history, a timeliness of payments, a transaction dispute history, a revolving transaction account balance, a delinquency history, a fraud score, a credit score, an income level, an education history, or a tax history, and wherein the historical transaction data comprises at least one of line item data, transaction authorization data, transaction submission data, or recent transaction data.

19. The article of manufacture of claim 16, wherein the trust score request comprises an identity claim associated with the user, and wherein the dynamic trust score is calculated based on the identity claim.

20. The article of manufacture of claim 16, further comprising:
encrypting, by the computer-based system, the dynamic trust score with a private key prior to storing the dynamic trust score on a digital identity management blockchain;
storing, by the computer-based system, the dynamic trust score on the digital identity management blockchain; and
transmitting, by the computer-based system, a public key to the merchant, wherein the public key is associated with the private key, and wherein the merchant uses the public key to retrieve the dynamic trust score from the digital identity management blockchain.
